(19) United States
(12) Patent Application Publication
(10) Pub. No.: US 2006/0015813 A1
(43) Pub. Date: Jan. 19, 2006

(54) Apparatus and method for reproducing interactive contents by controlling font according to aspect ratio conversion

(76) Inventors: Hyun-Kwon Chung, Seoul (KR); Kil-Soo Jung, Hwaseong-gun (KR)

Correspondence Address: STEIN, MCEWEN & BUI, LLP, 1400 EYE STREET, NW, SUITE 300, WASHINGTON, DC, 20005, US

(21) Appl. No.: 10/536,911

(22) PCT Filed: Nov. 26, 2003
(86) PCT No.: PCT/KR03/02573

§ 371 Date: May 27, 2005

(30) Foreign Application Priority Data
Nov. 27, 2002 (KR) 10-2002-0074479
Sep. 6, 2003 (KR) 2003-0062375

(51) Int. Cl. G06F 15/00; G06F 17/00

(52) U.S. Cl. 715/542; 715/513; 715/500.1; 715/530

(57) ABSTRACT

An apparatus and method to reproduce interactive content with control of a font according to an aspect ratio conversion are provided. The apparatus reproduces an interactive content from an information storage medium. The interactive content includes AV data including audio data and video data, a markup document, and/or a markup resource file. The apparatus includes a font decoder, which determines a pixel aspect ratio of a font according to aspect ratio information and resolution information of an input markup document, enlarges or reduces the font before displaying the font, and outputs font data resulting from the enlargement or reduction to a screen on which the interactive content is displayed so as to be adapted to an aspect ratio and a resolution of the screen. Accordingly, the interactive content may be displayed with a minimum distortion.

### CROSS-REFERENCE TO RELATED APPLICATIONS

This application claims the benefit of Patent Cooperation Treaty (PCT) Application No. PCT/KR2003/2573, filed Nov. 26, 2003, in the Korean Intellectual Property Office, which is based on Korean Patent Applications 2002-74479, filed Nov. 27, 2002, and 2003-62375, filed Sep. 6, 2003, in the Korean Intellectual Property Office, the disclosures of which are incorporated herein by reference.

### BACKGROUND OF THE INVENTION

1. Field of the Invention

An aspect of the present invention relates to a technique of reproducing an interactive content of an interactive display from an information storage medium, and, more particularly, to an apparatus and method of reproducing an interactive content by controlling a font according to an aspect ratio conversion, thereby minimizing display distortion.

2. Description of the Related Art

Generally, audio and/or video (AV) content information and user definition information are types of information that are recorded on an information storage medium. The AV content information is a content actually reproduced from the information storage medium, and the user definition information is unique information that is defined by a producer. When a general reproducing apparatus is used, only the AV content is reproduced from the information storage medium. When a device such as a computer is used, the user definition information may also be accessed and used.

Recently, interactive information storage media have been commercialized. The interactive information storage media may be used in a web-based environment using HyperText Markup Language (HTML) enabling a user interactive display. When information is reproduced from an interactive information storage medium, even when a general reproducing apparatus is used, a user can see an interactive image showing a tool, a text, or an image, which enables the user to access a network link and perform a search, together with an AV image showing an AV content.

FIGS. 1A and 1B show examples of a screen which can be displayed in an interactive mode. FIG. 1A shows a screen having an aspect ratio of 4:3 (hereinafter, referred to as a 4:3 screen). FIG. 1B shows a wide screen having an aspect ratio of 16:9.

Conventional interactive information storage media are manufactured to have a markup document suitable only for a 4:3 screen having a pixel aspect ratio of 1:1, such as a screen of a personal computer's monitor. Accordingly, when an interactive image is displayed on a screen of a television (TV), the interactive image is displayed in an undesired format because the TV screen does not have a 1:1 pixel aspect ratio, and accordingly has a different screen aspect ratio. In other words, when an HTML file that is suitable for a screen having a particular pixel aspect ratio is reproduced from a conventional interactive information storage medium and displayed on a screen (e.g., a 4:3 TV screen) having a different pixel aspect ratio from the particular pixel aspect ratio, the HTML file is not displayed in a format desired by a content producer, as shown in FIG. 2.

When an interactive image is displayed on a display apparatus having a different pixel aspect ratio, image distortion occurs and the image has a different shape from that which is desired by a content producer. Therefore, there is a need for a method of displaying an interactive content in a format desired by a content producer without distortion on a screen having a pixel aspect ratio different from that of a produced markup document.

### SUMMARY OF THE INVENTION

An aspect of the present invention provides an apparatus and method to reproduce interactive content by controlling a font according to an aspect ratio conversion so as to minimize display distortion.

Another aspect of the present invention provides an apparatus and method to reproduce interactive content by controlling a size of a font adapted to an aspect ratio conversion using aspect ratio information of a markup document containing the aspect ratio information and resolution information which are optimally suitable for the markup document so as to minimize display distortion.

Another aspect of the present invention provides an apparatus and method to reproduce interactive content by enlarging or reducing a font having a predetermined pixel aspect ratio according to a resolution and an aspect ratio of a screen on which the font is to be displayed so as to minimize display distortion.

According to an aspect of the present invention, there is provided an apparatus to reproduce an interactive content from an information storage medium. The interactive content includes AV data including audio data and video data, a markup document, and/or a markup resource file. The apparatus includes a font controller, which determines a pixel aspect ratio of a font according to aspect ratio information and resolution information of an input markup document, performs a preprocess of enlarging or reducing a size of the font according to the determined pixel aspect ratio, and outputs the preprocessed font data according to a change in the aspect ratio and resolution of the screen on which the interactive content is displayed.

According to an aspect of the present invention, there is provided a method of reproducing an interactive content from an information storage medium. The interactive content includes AV data including audio data and video data, a markup document, and/or a markup resource file. The method includes determining a pixel aspect ratio of a font according to aspect ratio information and resolution information of an input markup document, performing a preprocess of enlarging or reducing the font before displaying the font, and outputting the preprocessed font data according to an aspect ratio and a resolution of a screen on which the interactive content is displayed.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 1B show examples of a screen which can be displayed in an interactive mode;

FIG. 2 shows an example of distortion occurring when an image that is suitable for a screen having a 1:1 pixel aspect ratio is displayed on a screen having a 4:3 pixel aspect ratio without conversion;

FIG. 3 is a block diagram of a reproducing apparatus according to the present invention;

FIG. 4 is a block diagram of an apparatus to reproduce an interactive content by controlling a font according to an aspect ratio conversion, according to an embodiment of the present invention;

FIG. 5 illustrates rotation of a font using control point data of font outline;

FIGS. 6A and 6B show examples of font outputs according to prior art and an embodiment of the present invention, respectively;

FIGS. 7A and 7B show other examples of font outputs according to prior art and an embodiment of the present invention, respectively;

FIGS. 8A through 8C show other examples of font outputs according to an embodiment of the present invention and prior art; and

FIG. 9 is a flowchart of a method of reproducing an interactive content by controlling a font according to an aspect ratio conversion, according to an embodiment of the present invention.

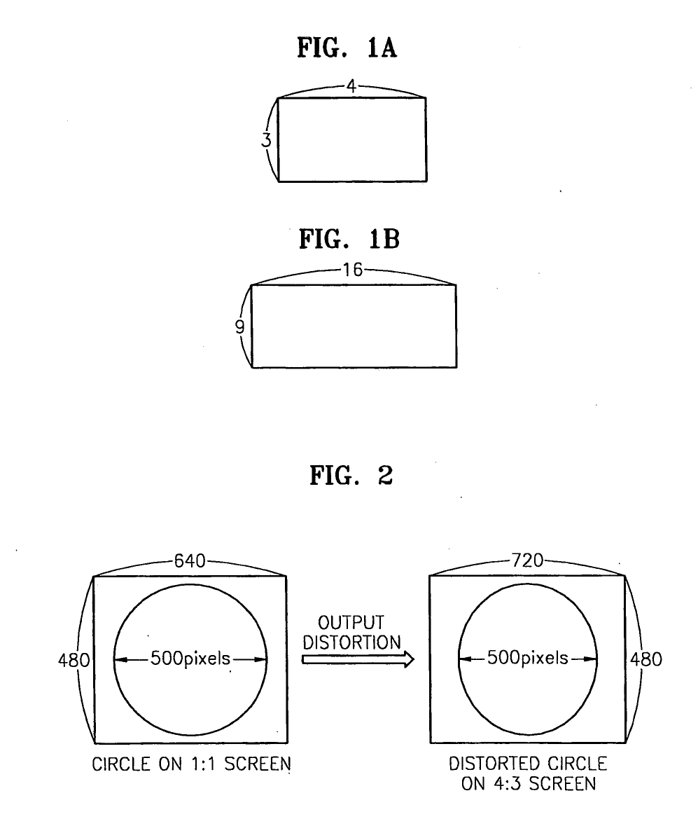

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

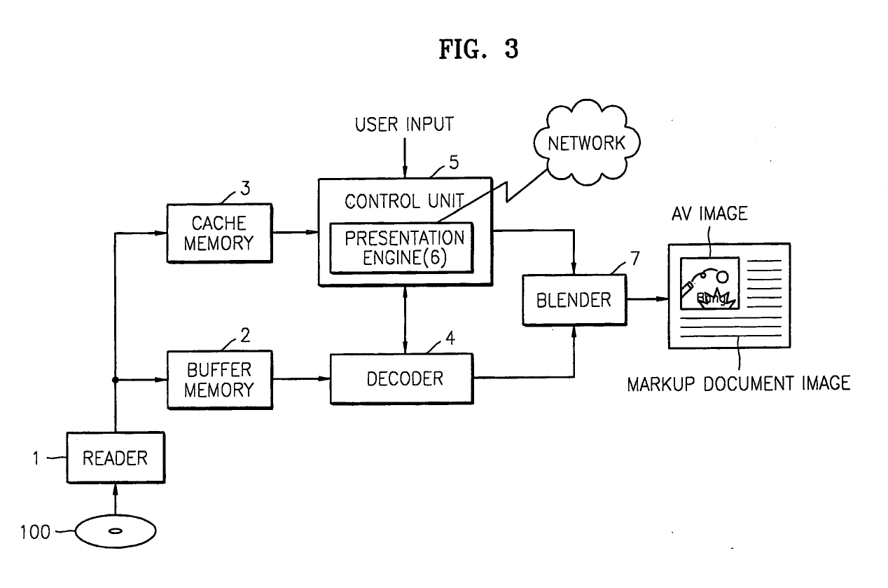

FIG. 3 is a block diagram of a reproducing apparatus according to an embodiment of the present invention. The reproducing apparatus includes a reader 1, a buffer memory 2, a cache memory 3, a decoder 4, a control unit 5, and a blender 7. The control unit 5 is provided with a presentation engine 6. The reader 1 includes an optical pickup unit (not shown), which reads data by radiating a laser beam onto an interactive information storage medium 100.

The interactive information storage medium 100 provides various types of information and AV contents, which may be displayed in a user interactive environment. The interactive information storage medium 100 has a markup document containing indication information on a resolution and an aspect ratio of the markup document so that an interactive image may be appropriately displayed at a particular screen aspect ratio. Generally, a font having a square pixel aspect ratio is used in a markup document, but a format of the font may vary with content producers.

The reader 1 controls the optical pickup unit to read AV data and a markup document from the interactive information storage medium 100 according to a control signal from the control unit 5. The buffer memory 2 buffers the AV data, and the cache memory 3 caches a playback control information file to control the playback of the AV data and/or the markup document or caches other necessary information. The control unit 5 controls the reader 1, the decoder 4, the presentation engine 6, and the blender 7 so that the AV data is reproduced from the interactive information storage medium 100 in a video mode or an interactive mode according to a user's selection.

The presentation engine 6 is an analytical engine to analyze markup languages and program languages such as JavaScript and Java. The presentation engine 6 may include various plugins. The plugins enable users to open markup resource files of various formats, which are included in or linked to markup documents. In other words, the presentation engines 6 serves as a markup document viewer. In an embodiment of the present invention, the presentation engines 6 may access the Internet and read predetermined data.

The presentation engines 6 fetches a markup document from the cache memory 3. Then, the presentation engine 6 analyzes and renders the markup document in the interactive mode. The blender 7 then blends an AV data stream and the rendered markup document so that the AV data stream is displayed on a display window defined by the markup document, that is, an AV image is embedded in a markup document image, and outputs the result of blending to a display apparatus 200.

In particular, the presentation engine 6 enlarges or reduces a font that is made at a square pixel aspect ratio using aspect ratio information of a markup document containing resolution information and the aspect ratio information which are suitable for the markup document in order to minimize distortion of interactive data. As a result, the interactive data may be displayed in the original font on a screen having a different resolution and aspect ratio from the original resolution and aspect ratio of the markup document without distortion.

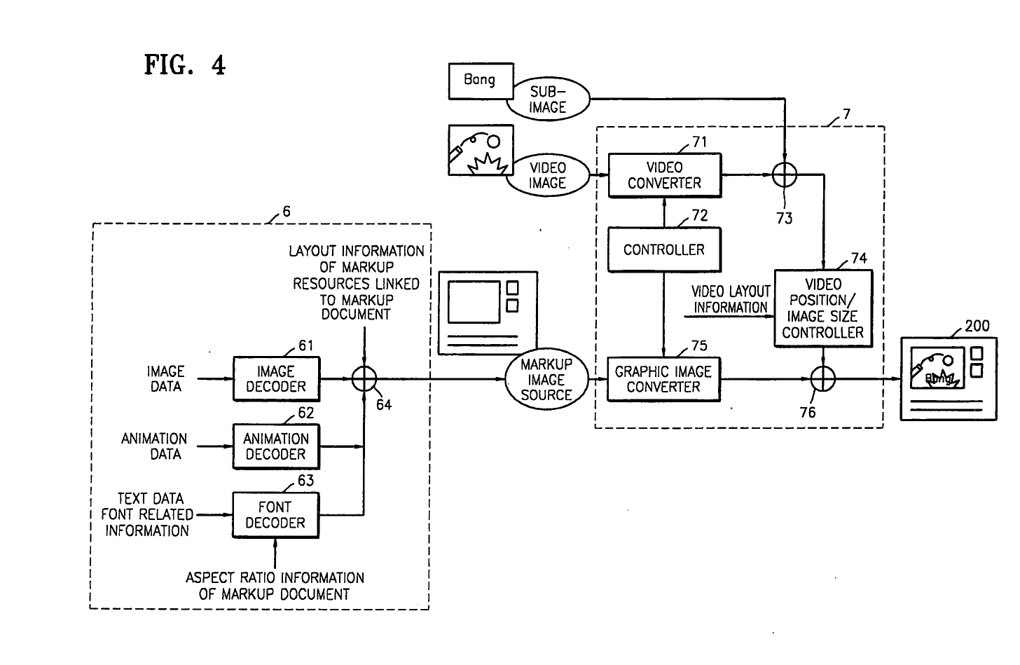

FIG. 4 is a block diagram of an apparatus to reproduce an interactive content with control of a font according to an aspect ratio conversion, according to an embodiment of the present invention. In FIG. 4, a sub-image is sub picture data overlapping a video image. The sub-image and the video image are provided from the decoder 4 shown in FIG. 3.

A video converter 71 is controlled by a controller 72 to convert a format of the video image into a pan & scan format or a letterbox format according to a screen aspect ratio and a resolution of the display apparatus 200 or to output the video image from the decoder 4 as is without a conversion thereof . A first mixer 73 mixes the video image from the video converter 71 and the sub-image. A video position/image size controller 74 controls a position of the mixed image from the first mixer 73 and a size of an AV image displayed on a screen of the display apparatus 200 according to input video layout information.

A graphic image converter 75 is controlled by the controller 72 to convert a size (a length or a width) of a graphic image of a markup image source provided from the presentation engine 6 according to aspect ratio information of a document. A second mixer 76 mixes an output of the video position/image size controller 74 and an output of the graphic image converter 76 and outputs the result of mixing to the display apparatus 200 so that the result of mixing may be displayed on the screen of the display apparatus 200. The controller 72 controls the video converter 71 and the graphic image converter 75 according to the screen aspect ratio and the resolution of the display apparatus 200. The blender 7 comprises the video converter 71, the controller 72, the first mixer 73, the video position/image size controller 74, the graphic image converter 75, and the second mixer 76.

Meanwhile, in an embodiment of the invention, an interactive image display file is a markup document, such as a web-based document file, made using a markup language or a markup resource file, such as an image, an animation, or a font.

Although not shown, the presentation engine 6 includes a markup document parser and a style sheet parser. A markup document is parsed by the markup document parser to generate a document tree, which conforms the following rules. Firstly, a root node of all nodes is set as a document node. Secondarily, all of the text and various elements in a document generate a node. Thirdly, a processing instruction, a comment, and a document type generate a node. The style sheet parser parses a style sheet, which allows a format of the markup document to be freely set, to generate a style rule and a selector list. The style sheet parser provides the video layout information input to the video position/image size controller 74 and layout information of markup resources linked to the markup document (referred to as markup resource layout information). The markup resource layout information is input to a markup image mixer 64.

Based on the document tree, an image decoder 61 decodes image data, an animation decoder 62 decodes animation data, and a font decoder 63 decodes text data according to font-related information to provide text data having an appropriate font. The font-related information may include unicode information (font information for international standardization) and font family information or may be font information stored in a reproducing apparatus as default.

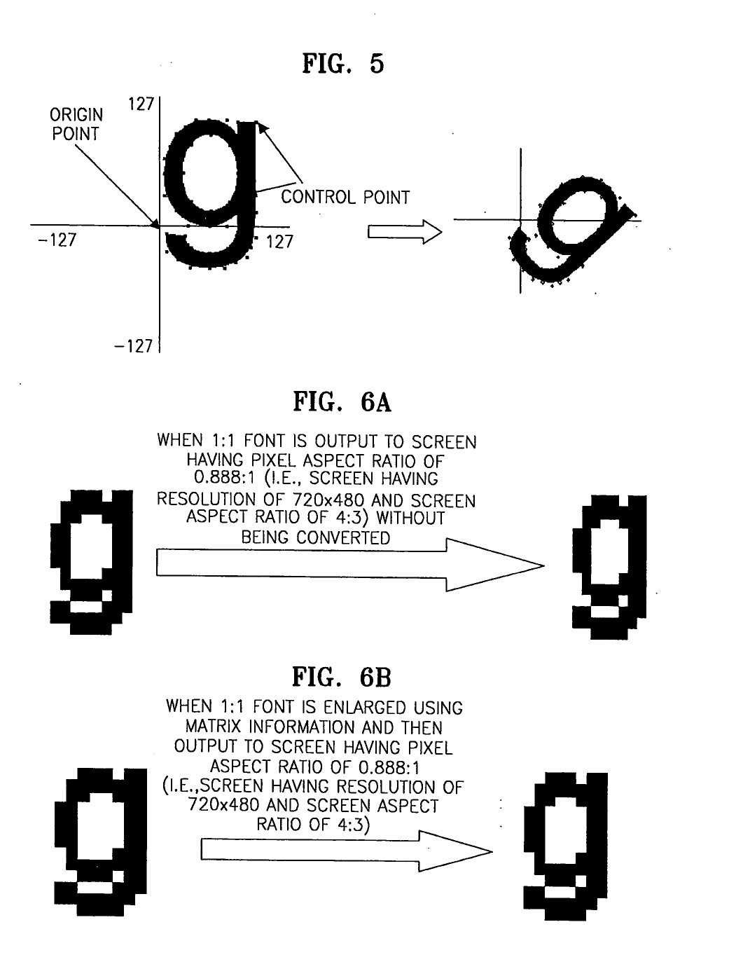

Particularly, the font decoder 63 enlarges or reduces a font using a matrix value that was previously set for the screen aspect ratio of the display apparatus 200 based on aspect ratio information of the markup document output from the markup document parser, and outputs font data. The operation of the font decoder 63 will be described in detail later with reference to FIGS. 5 through 9.

The markup image mixer 64 mixes outputs of the image decoder 61, the animation decoder 62, and the font decoder 63 according to the markup resource layout information to generate a markup image source and provides the markup image source to the graphic image converter 75 of the blender 7.

The presentation engine 6 comprises the image decoder 61, the animation decoder 62, the font decoder 63, the markup image mixer 64, and other units (not shown).

In an embodiment of the invention, a markup document displayed in an interactive image contains resolution information and aspect ratio information indicating a 16:9 screen, a 4:3 screen, a 1:1 screen, or no-relation to the screen aspect ratio which includes a case where no aspect ratio is set for the markup document. Table 1 shows examples of the resolution information and the aspect ratio information. When the markup document contains neither the resolution information nor the aspect ratio information, basic screen information set in a reproducing apparatus can be utilized. For example, the basic screen information may include a horizontal resolution of 720 pixels, a vertical resolution of 480 pixels, and an aspect ratio of 14:9.

TABLE 1

| | | | | |
|---|---|---|---|---|
| Pixel | 1:1 | 0.888:1 | 1.186:1 | Only |
| aspect | | | | resolution |
| ratio | | | | without pixel |
| | | | | aspect ratio |
| | | | | is set |
| Examples | R720 × 405, | R720 × 480, | R720 × 480, | R720 × 480 |
| of use | A1 × 1 | A4 × 3 | A16 × 9 | R720 × 576 |
| | R720 × 540, | R720 × 576, | R720 × 576, | R1920 × 1080 |
| | A1 × 1 | A4 × 3 | A16 × 9 | R960 × 540 |
| | R1920 × 1080, | | | |
| | A1 × 1 | | | |

The resolution information and the aspect ratio information of the markup document may be embedded into the markup document using a tag, for example, <meta name=“bestlook”content=“Rresolution value,Aaspect ratio value”>. In an example of modification, <link href=“foo.css” type=“text/css” device-aspect-ratio=“aspect ratio value”/>may be used. The resolution information and the aspect ratio information indicate a resolution and an aspect ratio at which the markup document is displayed most optimally. The following is an example of a markup document in which an aspect ratio and a resolution are combined.

<?xml version=“1.0” encoding =“UTF-8”?>
<!DOCTYPE html PUBLIC-//DVD/DTD XHTML DVD-HTML1.0//EN”
“http://www.dvdforum.org/enav/dvdhtml-1.0.dtd”>
<html>
<head>
<title>720×480, 4×3 PAGE</title>
<meta name=“bestlook” content=“R720×480,A4×3”/>
<link href=“foo.css” type=“text/css” device-aspect-ratio=“4:3”/>
<script language=“ecmascipt”>
<![CDATA[
function onload_handler( )
{

idplayer.play( );
idplayer.enable VideoTransform(0);
//Disable first video transform when a value is 0 and
enable first video

transform when a value is 1.

}

]]>
</script>
</head>
</body id=“ docbody” onload=“onload_handler( )”>
<objet style=“ position: absolute; left: 150px; top: 100px; width: 370px;
height:250px“ data=“dvd:video_ts” id=“idplayer”/>
Interactive Data
</body>
</html>

Generally, fonts are produced on a screen having a 1:1 (square) pixel aspect ratio. Information on a font is composed of a coordinate point, and thus a two-dimensional transformation such as enlargement, reduction, or rotation may be easily performed using control point data of a font outline, as shown in FIG. 5. However, a TV screen does not have the square pixel aspect ratio. As shown in Table 2, when a screen aspect ratio is 4:3, a pixel aspect ratio is 0.888:1. When a screen aspect ratio is 16:9, a pixel aspect ratio is 1.186:1.

TABLE 2

| | | |
|---|---|---|
| Screen aspect ratio at 720 × 480 (NTSC) | 4:3 | 16:9 |
| Pixel aspect ratio | 0.888:1 | 1.186:1 |

Accordingly, when a font having the square pixel aspect ratio (hereinafter, referred to as a 1:1 font) is output to the TV screen without being changed, phenomena described below may occur. As shown in FIG. 6A, when a 1:1 font is output to a screen having a pixel aspect ratio of 0.888:1 (i.e., a screen having a resolution of 720×480 and a screen aspect ratio of 4:3) without being converted, the 1:1 font becomes narrow. When an interactive content is displayed, if the 1:1 font is enlarged at a ratio of 1.125:1 and then output to the screen having a pixel aspect ratio of 0.888:1, the 1:1 font can be displayed normally. Accordingly, the font decoder 63 enlarges the 1:1 font at the ratio of 1.125:1 using matrix information and then outputs the enlarged font to the 4:3 screen so that the font may be displayed normally. In other words, the enlarged font is reduced at a ratio of 0.999:1 on the screen having a pixel aspect ratio of 0.888:1 (i.e., the screen having a resolution of 720×480 and a screen aspect ratio of 4:3) and thus looks like the 1:1 font, as shown in FIG. 6B.

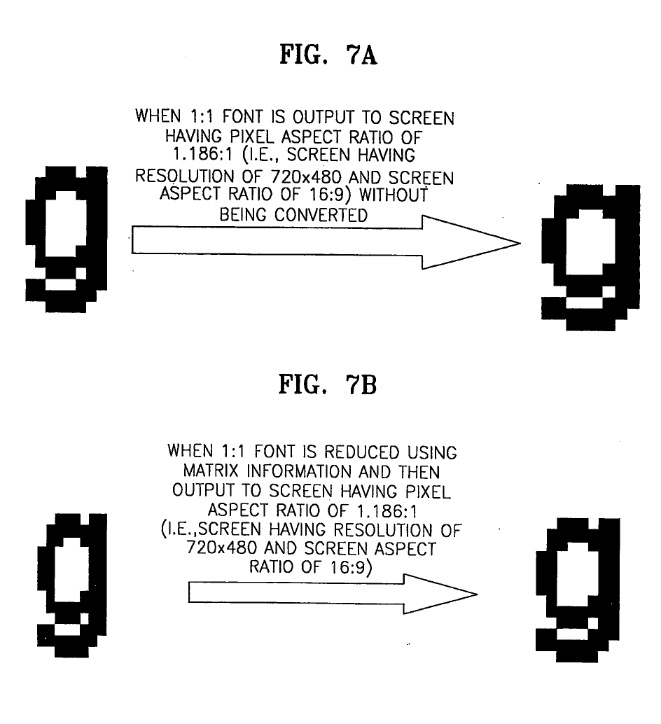

As shown in FIG. 7A, when a 1:1 font is output to a screen having a pixel aspect ratio of 1.186:1 (i.e., a screen having a resolution of 720×480 and a screen aspect ratio of 16:9) without being converted, the 1:1 font becomes wide. When an interactive content is displayed, if the 1:1 font is reduced at a ratio of 0.843:1 and then output to the screen having a pixel aspect ratio of 1.186:1, the 1:1 font may be displayed normally. Accordingly, the font decoder 63 reduces the 1:1 font at the ratio of 0.843:1 using matrix information and then outputs the reduced font to the 16:9 screen so that the font can be displayed normally. In other words, the reduced font is enlarged at a ratio of 0.999:1 on the screen having a pixel aspect ratio of 1.186:1 (i.e., the screen having a resolution of 720×480 and a screen aspect ratio of 16:9) and thus looks like the 1:1 font, as shown in FIG. 7B.

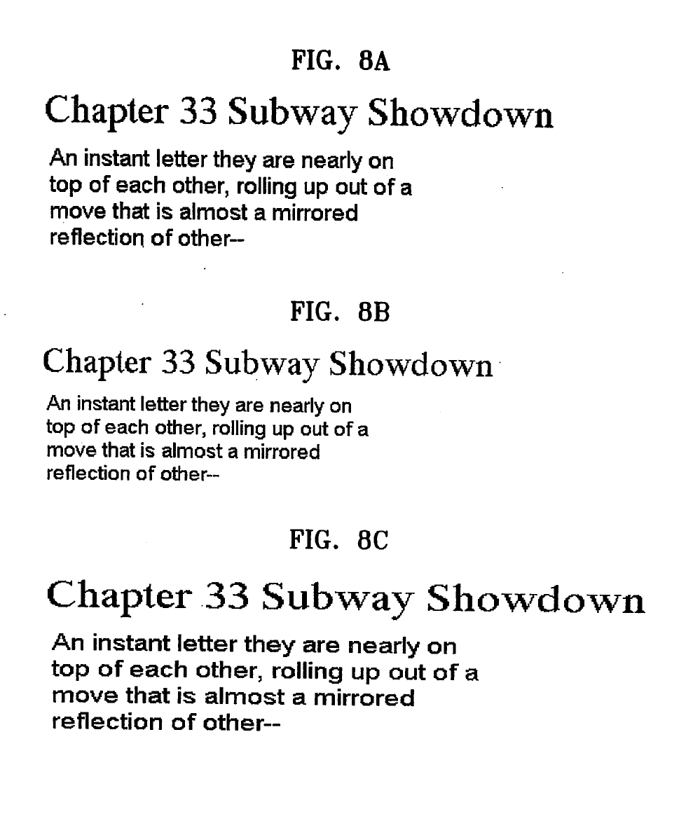

FIG. 8A shows an example of text data normally displayed when the font decoder 63 enlarges or reduces a 1:1 font according to a screen aspect ratio. FIG. 8B shows an example of the text data narrowly displayed when the 1:1 font is output to a screen having a pixel aspect ratio of 0.888:1 (i.e., a screen having a resolution of 720×480 and a screen aspect ratio of 4:3) without being converted. FIG. 8C shows an example of the text data widely displayed when the 1:1 font is output to a screen having a pixel aspect ratio of 1.186:1 (i.e., a screen having a resolution of 720×480 and a screen aspect ratio of 16:9) without being converted.

The font decoder 63 stores values to enlarge or reduce a font according to aspect ratio information contained in a markup document as matrix information, as shown in Table 3. Table 3 shows a matrix used for a 4:3 screen (having a pixel aspect ratio of 0.888:1 and a resolution of 720×480), a matrix used for a 16:9 screen (having a pixel aspect ratio of 1.186:1 and a resolution of 720×480), a matrix used for a basic 14:9 screen (having a pixel aspect ratio of 1.031:1 and a resolution of 720×480), and a matrix used for a screen having a pixel aspect ratio of 1:1 (wherein a resolution is 960×540 or 1920×1080).

TABLE 3

| | | | | |
|---|---|---|---|---|
| Pixel aspect ratio | 0.888:1 | 1.186:1 | 1.031:1 | 1:1 |
| Matrix information | $[ \begin{matrix}1.125 & 0 \\ 0 & 1\end{matrix} ]$ | $[ \begin{matrix}0.843 & 0 \\ 0 & 1\end{matrix} ]$ | $[ \begin{matrix}0.3 & 0 \\ 0 & 1.0\end{matrix} ]$ | $[ \begin{matrix}1 & 0 \\ 0 & 1\end{matrix} ]$ |

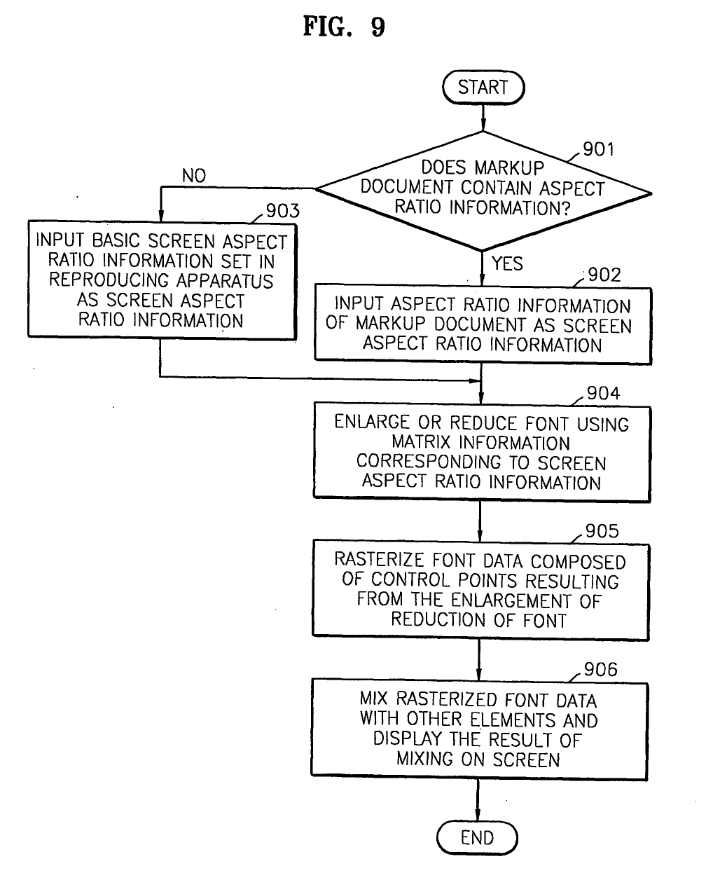

FIG. 9 is a flowchart of a method of reproducing an interactive content by controlling a font according to an aspect ratio conversion, according to an embodiment of the present invention. FIG. 9 shows an example of the operation of the font decoder 63 implemented in software.

Initially, whether a markup document contains aspect ratio information, for example, whether a markup document contains a tag <meta name=“bestlook” content=“Rresolution value,Aaspect ratio value”>or a modified tag <link href=“foo.css” type=“text/css” device-aspect-ratio=“aspect ratio value”/>(901) is determined. If the markup document is determined to contain the aspect ratio information, the aspect ratio information is input as screen aspect ratio information (902). If the markup document is determined to not contain the aspect ratio information, basic screen aspect ratio information set in a reproducing apparatus is input as the screen aspect ratio information (903). A font is enlarged or reduced using matrix information (as shown in FIG. 3) corresponding to the screen aspect ratio information (904). Then, font data composed of control points resulting from the enlargement or reduction of the font is rasterized for display (905). Thereafter, the rasterized font data is mixed with other elements (an image, animation, etc.), and the result of mixing is displayed on a screen (906).

### INDUSTRIAL APPLICABILITY

As is described above, according to aspects of the present invention, when interactive image information optimally displayed at a particular aspect ratio is reproduced from an information storage medium and displayed on a screen having a different screen aspect ratio from the particular aspect ratio, a font is enlarged or reduced using matrix information corresponding to the particular aspect ratio, so that the original font desired by a content producer can be normally displayed on the screen, and an interactive image can be displayed on the screen with a minimum distortion.

Although a few embodiments of the present invention have been shown and described, it would be appreciated by those skilled in the art that changes may be made in this embodiment without departing from the principles and spirit of the invention, the scope of which is defined in the claims and their equivalents.

1. An apparatus to reproduce interactive content from an information storage medium, the interactive content including audio/visual (AV) data including audio data and video data, a markup document, and/or a markup resource file, the apparatus comprising:
a font controller to determine a pixel aspect ratio of a font according to aspect ratio information and resolution information of the markup document, to performs a preprocess of enlarging or reducing a size of the font according to the determined pixel aspect ratio, and to outputs the preprocessed font data according to a change in the aspect ratio and resolution of the screen on which the interactive content is displayed.

2. The apparatus of claim 1, wherein the aspect ratio information is embedded in the markup document using a tag.

3. The apparatus of claim 2, wherein the markup document contains resolution information and screen aspect ratio information indicating a 16:9 screen, a 4:3 screen, a 1:1 screen, or no-relation to the screen aspect ratio which includes a case where no aspect ratio is set for the markup document.

4. The apparatus of claim 2, wherein when the tag for the aspect ratio information of the markup document does not exist in the markup document, basic screen aspect ratio information set in the reproducing apparatus is used as screen aspect ratio information of the markup document.

5. The apparatus of claim 1, wherein the font controller stores matrix information indicating values to enlarge or reduce the font according to the aspect ratio information of the markup document.

6. The apparatus of claim 5, wherein the matrix information comprises a matrix used for an aspect ratio of 4:3, a matrix used for an aspect ratio of 16:9, a matrix used for a basic aspect ratio of 14:9, and a matrix used for an aspect ratio of 1:1.

7. An apparatus to reproduce interactive content from an information storage medium, the interactive content including audio/visual (AV) data including audio data and video data, a markup document, and/or a markup resource file, the apparatus comprising:
a reader, to read data from the information storage medium; and
a presentation engine, to enlarge or reduces a font, made at a predetermined pixel aspect ratio, using aspect ratio information of the markup document read by the reader, the markup document containing the aspect ratio information and resolution information which are optimally suitable to the markup document, and to outputs the enlarged or reduced font according to a screen having a different aspect ratio and resolution from the aspect ratio information and the resolution information contained in the markup document with a minimum distortion.

8. The apparatus of claim 7, wherein the aspect ratio information is embedded in the markup document using a tag.

9. The apparatus of claim 8, wherein when the tag for the aspect ratio information of the markup document does not exist in the markup document, basic screen aspect ratio information set in the reproducing apparatus is used as screen aspect ratio information of the markup document.

10. The apparatus of claim 9, wherein the presentation engine comprises a font decoder, which stores matrix information indicating values for enlarging or reducing the font according to the aspect ratio information of the markup document.

11. The apparatus of claim 10, wherein the matrix information comprises a matrix used for an aspect ratio of 4:3, a matrix used for an aspect ratio of 16:9, a matrix used for a basic aspect ratio of 14:9, and a matrix used for an aspect ratio of 1:1.

12. The apparatus of claim 7, wherein the markup document contains resolution information and screen aspect ratio information indicating a 16:9 screen, a 4:3 screen, a 1:1 screen, or no-relation to the screen aspect ratio which includes a case where no aspect ratio is set for the markup document.

13. The apparatus of claim 12, wherein, when the screen aspect ratio information indicates the 4:3 screen, the font decoder enlarges the font having a square pixel aspect ratio to have a first ratio and outputs the enlarged font to the 4:3 screen so that the enlarged font having the first ratio is reduced and displayed at almost the square pixel aspect ratio on the 4:3 screen.

14. The apparatus of claim 12, wherein, when the aspect ratio information indicates the 16:9 screen, the font decoder reduces the font, having a square pixel aspect ratio to have a second ratio and outputs the reduced font to the 16:9 screen so that the reduced font having the second ratio is enlarged and displayed at almost the square pixel aspect ratio on the 16:9 screen.

15. The apparatus of claim 7, further comprising:
a decoder, to decode the AV data read by the reader and to outputs a video image and a sub-image; and
a blender, to blend the AV data and a rendered markup document so that the AV data is displayed on a display window of a display apparatus defined by the markup document,
wherein the blender comprises:
a video converter, which convert to convert a format of the video image into a pan and scan format or a letterbox format according to a screen aspect ratio and a resolution of the display apparatus or to outputs the video image as without a conversion thereof,
a first mixer, to mix the video image from the video converter and the sub-image,
a video position/image size controller, to control a position of the mixed image from the first mixer and a size of an AV image displayed on a screen of the display apparatus according to input video layout information,
a graphic image converter, to convert a size of a graphic image of a markup image source provided from the presentation engine,
a second mixer, to mix an output of the video position/image size controller and an output of the graphic image converter and to outputs the result of mixing to the display apparatus so that the result of mixing may be displayed on the screen of the display apparatus, and
a controller, to control the video converter and the graphic image converter according to the screen aspect ratio and the resolution of the display apparatus.

16. A method of reproducing an interactive content from an information storage medium, the interactive content including audio/visual (AV) data including audio data and video data, a markup document, and/or a markup resource file, the method comprising:
determining a pixel aspect ratio of a font according to aspect ratio information and resolution information of an input markup document;
performing a preprocess of enlarging or reducing the font before displaying the font; and
outputting the preprocessed font data according to an aspect ratio and a resolution of a screen on which the interactive content is displayed.

17. The method of claim 16, wherein the aspect ratio information of the markup document is embedded in the markup document using a tag.

18. The method of claim 17, wherein the determining the pixel aspect ratio comprises setting basic screen aspect ratio information set in the apparatus as screen aspect ratio information of the markup document when the tag for the aspect ratio information of the markup document does not exist in the markup document.

19. The method of claim 18, wherein the markup document contains the resolution information and the aspect ratio information indicating a 16:9 screen, a 4:3 screen, a 1:1 screen, or no-relation to the screen aspect ratio which includes a case where no aspect ratio is set for the markup document.

20. The method of claim 16, wherein the enlarging or reducing the font comprises converting the font using matrix information indicating values to enlarge or reduce the font according to the aspect ratio information of the markup document.

21. The method of claim 20, wherein the matrix information comprises a matrix used for an aspect ratio of 4:3, a matrix used for an aspect ratio of 16:9, a matrix used for a basic aspect ratio of 14:9, and a matrix used for an aspect ratio of 1:1.

22. The method of claim 20, wherein, when the screen aspect ratio information indicates the 4:3 screen, the enlarging or reducing the font comprises enlarging the font having a square pixel aspect ratio to have a first ratio, and outputting the font data comprises outputting the enlarged font to the 4:3 screen, so that the enlarged font having the first ratio is reduced and displayed at almost the square pixel aspect ratio on the 4:3 screen.

23. The method of claim 20, wherein, when the aspect ratio information indicates the 16:9 screen, the enlarging or reducing the font comprises reducing the font having a square pixel aspect ratio to have a second ratio, and outputting the font data comprises outputting the reduced font to the 16:9 screen, so that the reduced font having the second ratio is enlarged and displayed at almost the square pixel aspect ratio on the 16:9 screen.

24. The apparatus of claim 7, further comprising a decoder to decode the AV data read by the reader and to output a video image and a sub-image.

25. The apparatus of claim 24, further comprising a blender to blend the AV data and a rendered markup document so that the AV data is displayed on a display window of a display apparatus defined by the markup document.

26. The apparatus of claim 25, wherein the blender comprises a video converter to convert a format of the video image into one of a pan and scan format and a letterbox format according to a screen aspect ratio and a resolution of the display apparatus or to output the video image as is without a conversion thereof.

27. The apparatus of claim 26, further comprising a first mixer to mix the video image from the video converter and the sub-image.

28. The apparatus of claim 27, further comprising: a video position/image size controller to control a position of the mixed image from the first mixer and a size of an AV image displayed on the screen according to input video layout information.

29. The apparatus of claim 28, further comprising a graphic image converter to convert a size of a graphic image of a markup image source provided from the presentation engine.

30. The apparatus of claim 29, further comprising a second mixer to mix an output of the video position/image size controller and an output of the graphic image converter and to output the result of mixing to the display apparatus so that the result of mixing is displayable on the screen of the display apparatus.

31. The apparatus of claim 30, further comprising a controller to control the video converter and the graphic image converter according to the screen aspect ratio and the resolution of the display apparatus.

32. A reproducing apparatus, including a reader to read audio/visual (AV) data and a markup document from a storage medium, the markup document indicating a resolution and an aspect ratio of the markup document, a buffer to buffer the AV data, a cache to cache a playback control information file to control the playback of the AV data and/or the markup document, and a decoder to decode the cached AV data and the markup document, the apparatus comprising:
a control unit to control the reader, the buffer, the cache, and the decoder to read the AV data and the markup document from the medium;
a presentation engine to fetch the markup document from the cache and to enlarge or reduce a font originally having a first resolution and a first aspect ratio so as to render the markup document at a second resolution and a second aspect ratio; and
a blender to blend the AV data and the rendered markup document.

33. The apparatus according to claim 32, wherein the font has a square pixel aspect ratio and is used in the markup document.

34. The apparatus according to claim 32, wherein the presentation engine is an analytical engine to analyze markup languages and program languages.

35. The apparatus according to claim 32, wherein the presentation engine includes plugins to enable users to open markup resource files of various formats.

36. The apparatus according to claim 32, wherein the presentation engine accesses the Internet.

37. The apparatus according to claim 32, wherein the font that is enlarged or reduced by the presentation engine is made at a square pixel aspect ratio and is enlarged or reduced using aspect ratio information of the markup document.

38. The apparatus according to claim 32, wherein the rendered markup document is rendered at the second resolution and the second aspect ratio without distortion.

39. The apparatus according to claim 32, wherein the markup document comprises an interactive image display file.

40. An apparatus for use with a display apparatus to reproduce interactive content, including a video image and a sub-image, and to control a font according to an aspect ratio conversion, the apparatus comprising:
a video converter to convert a format of the video image into a pan and scan format or a letterbox format according to a screen aspect ratio and a resolution of the display apparatus or to output the video image without a conversion thereof;
a first mixer to mix the video image from the video converter and the sub-image;
a video position/image size controller to control a position of the mixed image and a size of a displayed audio/visual (AV) image according to input video layout information;
a graphic image converter to convert a size of a graphic image of a markup image source according to aspect ratio information of a markup document associated with the markup image;
a second mixer to mix an output of the video position/image size controller and an output of the graphic image converter and to output the result of mixing.

41. The apparatus according to claim 40, further comprising:
a display to display the interactive content; and
a controller to control the video converter and the graphic image converter according to the screen aspect ratio and the resolution of the display.

42. The apparatus according to claim 40, wherein the markup document is an interactive image display file.

43. A method of reproducing interactive content to be used with a reproducing apparatus, comprising:
determining whether a markup document contains aspect ratio information;
inputting the aspect ratio information as screen aspect ratio information, if the markup document contains the aspect ratio information;
inputting basic screen aspect ratio information set in the reproducing apparatus as the screen aspect ratio information, if the markup document does not contain the aspect ratio information;
enlarging or reducing a font of the markup document using matrix information corresponding to the inputted screen aspect ratio information;
rasterizing font data composed of control points resulting from the enlargement or reduction of the font for display; and
displaying the rasterized font data.
